(19) United States
(12) Patent Application Publication
(10) Pub. No.: US 2014/0196521 A1
(43) Pub. Date: Jul. 17, 2014

(54) DETECTION OF DIESEL EXHAUST FLUID CONTAMINATION

(71) Applicant: CATERPILLAR INC., Peoria, IL (US)

(72) Inventor: Amiyo Kumar BASU, Peoria, IL (US)

(73) Assignee: CATERPILLAR INC., Peoria, IL (US)

(21) Appl. No.: 13/742,683

(22) Filed: Jan. 16, 2013

(51) Int. Cl. G01N 25/72

(52) U.S. Cl. CPC G01N 25/72
USPC 73/25.01

(57) ABSTRACT

A method for detecting contamination in diesel exhaust fluid (DEF) used in a selective catalytic reduction process is disclosed. The method may include providing a plurality of temperature sensors arranged along a fluid column within a tank containing the DEF to be tested. The method may further include detecting a temperature of the fluid at each of the plurality of temperature sensors along the fluid column, determining temperature gradients along the fluid column from the temperatures detected by the plurality of temperature sensors, and comparing the temperature gradients along the fluid column with a set of reference temperature gradients.

### TECHNICAL FIELD

The present disclosure relates generally to a method for detecting contamination in a fluid and, more particularly, a method for detecting contamination of diesel exhaust fluid.

### BACKGROUND

Diesel Exhaust Fluid (DEF) is an aqueous urea solution often blended with 32.5% high purity urea and 67.5% deionized water. DEF is a reductant used in Selective Catalytic Reduction (SCR) to lower the concentration of nitrogen oxides (NOₓ) in the exhaust emissions from diesel engines. The solution is sometimes referred to in the industry as AUS32. DEF is injected into the exhaust as it moves through the engine, or downstream of the engine, where it vaporizes and decomposes to form ammonia (NH₃) and carbon dioxide. With an SCR catalyst, the NOₓ are catalytically reduced by the NH₃ in the DEF into water (H₂O) and nitrogen (N₂), which are both harmless and are released through the exhaust. One problem associated with DEF used in SCR is that it can be contaminated with fluids such as diesel fuel, slat water, home-made DEF, sugar water, and other elements or compounds. Injection of these contaminated fluids can damage the engine or cause other problems such as the release of undesirable emissions.

One attempt to check the composition of a DEF, such as an ammonia precursor solution, is disclosed in publication WO2007104779A2, assigned to Inergy Automotive Systems Research (the '779 publication). The '779 publication discloses a method for checking the composition of an ammonia precursor solution by plotting a change in temperature of a reference sample of the solution having the optimal concentration as a function of time. The reference sample is tested under conditions including a temperature range encompassing a change of state of the solution. A test sample of the solution is then checked by subjecting the test sample to the same temperature range and conditions as the reference sample. The curves of change in temperature as a function of time for the test sample and the reference sample are then compared.

Although the method of checking the composition of a DEF disclosed in the '779 publication may allow for detection of contaminates under certain conditions, such as during a change of state of the solution, it may be less than optimal as a way of detecting contamination of DEF under conditions other than during a change of state of the solution.

The system and method of the present disclosure solves one or more problems set forth above and/or other problems in the art.

### SUMMARY

In one aspect, the present disclosure is directed to a method of detecting contamination in Diesel Exhaust Fluid (DEF) contained within a tank including a plurality of temperature sensors arranged along a fluid column defined within the tank. The method may include detecting a temperature of the fluid at each of the plurality of temperature sensors along the fluid column. The method may also include determining temperature gradients along the fluid column from the temperatures detected by the plurality of temperature sensors, and comparing the temperature gradients along the fluid column with a set of reference temperature gradients.

In another aspect, the present disclosure is directed to an apparatus for detecting contamination in a tank of DEF containing reductant used in a selective catalytic reduction process. The apparatus may include a plurality of temperature sensors arranged along a fluid column within the tank, each of the temperature sensors configured to detect a temperature of the fluid at the position of each of the plurality of temperature sensors along the fluid column. The apparatus may also include a controller configured to determine temperature gradients along the fluid column from the temperatures detected by the plurality of temperature sensors.

### BRIEF DESCRIPTION OF THE DRAWINGS

FIG. 1 is a schematic illustration of an exemplary disclosed system for detecting contamination of DEF;

FIG. 2 is a flowchart depicting an exemplary disclosed method that may be performed by the system of FIG. 1.

### DETAILED DESCRIPTION

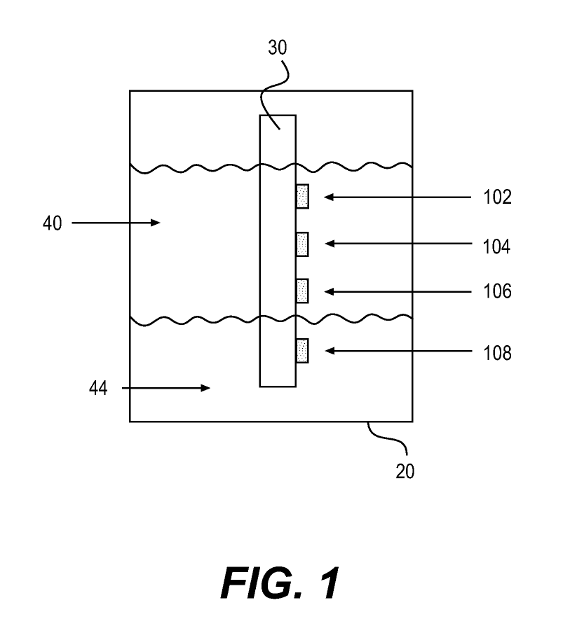

FIG. 1 illustrates an exemplary DEF contamination detection system. A tank 20, or other container, may contain the DEF as an aqueous urea solution. The aqueous urea solution may be used as a reductant in SCR performed as part of exhaust aftertreatment. In one non-limiting implementation, the solution contained within tank 20 may include approximately 32.5% high purity urea 44 and approximately 67.5% deionized water or other non-DEF fluids 40. DEF of the recommended composition may be injected into the exhaust as it moves through the engine, or downstream of the engine, where it vaporizes and decomposes to form ammonia (NH₃) and carbon dioxide (CO₂). With an SCR catalyst, the NOₓ may be catalytically reduced by the NH₃ in the DEF into water (H₂O) and nitrogen (N₂), which are both harmless and may be released through the exhaust.

Emissions control may be an important factor in engine design and engine control. One particular combustion by-product, NOₓ, is created by nitrogen and oxygen molecules present in engine intake air disassociating in the high temperatures of combustion. Rates of NOₓ creation may include known relationships to the combustion process, for example, with higher rates of NOₓ creation being associated with higher combustion temperatures and longer exposure of air molecules to the higher temperatures. Reduction of NOₓ created in the combustion process and management of NOₓ in an exhaust aftertreatment system may be important in vehicle design.

Exhaust aftertreatment devices, such as devices that perform SCR, convert NOₓ to nonpolluting molecules at some conversion efficiency. Conversion efficiency can be described by the flow of NOₓ flowing into a device versus the flow of NOₓ exiting the device. An aftertreatment device operating properly may experience reduced efficiency according to properties of the exhaust gas flow that affect the chemical reaction occurring in the device. For example, temperature and velocity of the gases within an SCR device may affect the efficiency of the device. Additionally, the quantity and quality of the reductant used by the SCR device may have a significant impact on the efficiency of the device. These environmental factors can be monitored in the aftertreatment system, and effects of these factors upon device conversion efficiency can be estimated. Additionally, malfunctions or degraded performance caused by wear or damage can reduce the efficiency of the aftertreatment device.

The presence of an insufficient quantity of reductant, or contaminated reductant within the SCR device that may affect the efficiency of the SCR can have many causes. For instance, if tank 20 contains a low level of the reductant used in SCR, then insufficient reductant may be present during SCR to maximize conversion efficiency. Another cause for insufficient reductant in the SCR device may be contamination or dilution of reductant 44 in tank 20. If deionized water or other non-DEF fluid 40 is incorrectly added or added in greater quantities than necessary for the proper ratio to urea in tank 20, the efficiency of the SCR device may be greatly reduced. In addition, contaminants or improper compositions in the supply of DEF in tank 20 may cause damage to the catalyst material with which the reductant reacts to remove NOₓ from exhaust gases during an exhaust gas aftertreatment process.

As shown in FIG. 1, a plurality of temperature sensors 102, 104, 106, 108 may be arranged within tank 20 along a fluid column 30 within tank 20. Although fluid column 30 is illustrated in the implementation of FIG. 1 as a straight column oriented vertically in tank 20, it is contemplated that fluid column 30 could be any number of different configurations. In some implementations, fluid column 30 may have a staggered, or stepped configuration, or any other form factor that may be at least partially dictated by the configuration of tank 20. Temperature sensors 102, 104, 106, 108 may be thermistors or any other temperature-sensing elements, such as thermocouples. A thermistor is a type of resistor whose resistance varies significantly with temperature. Thermistors are typically able to achieve a high level of precision within a limited temperature range. Fluid column 30 may be defined by a wall or other partition within tank 20 to form a separate compartment, or may simply be a defined area within tank 20, or an area defined by at least a portion of the internal configuration of tank 20. Different densities of different types of fluids, or fluids having different compositions contained within tank 20 may cause the fluids to separate into regions or zones. As shown in the exemplary embodiment of FIG. 1, a first zone of tank 20 may contain DEF having 32.5% high purity urea 44, and a second zone separated from the first zone of tank 20 may contain other non-DEF fluids 40. Fluid column 30 may be defined to extend across the several zones or regions of different types or compositions of fluid within tank 20, and temperature sensors 102, 104, 106, 108 may be spaced along fluid column 30 to detect temperatures along fluid column 30. Although FIG. 1 illustrates 4 temperature sensors positioned along fluid column 30, one of ordinary skill in the art will recognize that the number of temperature sensors may be varied to include 2, 3, 5, 6, or any other number of temperature sensors, and as discussed above, the shape of fluid column 30, and position of fluid column 30 within tank 20 may also be varied without departing from the scope of this disclosure. Alternative implementations may also include fluid column 30 being defined by a wall or plurality of walls of different configurations, permeability, materials, orientation, and position. The temperature sensors may also be combined with other sensors, such as level sensors for detecting the quantity of fluid contained within tank 20.

Temperature sensors 102, 104, 106, 108 may be installed and configured to detect temperatures throughout tank 20. In accordance with various implementations of this disclosure, a controller or other processor (not shown), such as may form part of or be associated with an engine control module (ECM), may be configured to receive signals from the temperature sensors indicative of the temperatures at specific points along fluid column 30 within tank 20, and at different points in time. The controller may receive these temperature signals and evaluate the signals to determine temperature gradients throughout the length of fluid column 30. The temperature gradients may be at least one of gradients based on relative position within tank 20, and gradients that may occur over time. These temperature gradients may also be tracked over time and/or position within tank 20 during different operating phases of an engine utilizing the DEF in an exhaust aftertreatment process. For example, temperature gradients along column 30 may be measured during the starting phase of an engine and when the starting phase is occurring with ambient temperatures falling within a particular range. The changes in temperature as a function of time measured at each of the positions along fluid column 30 may also be tracked by a controller or processor and used to form a trend line or identify a behavioral pattern for temperatures of the DEF within tank 20. The controller may be further configured to compare the resulting trend line or behavioral pattern for temperatures along fluid column 30 with trend lines or other data retrieved from a dataset or determined under similar conditions for a reference sample of DEF having a desired composition.

Temperature dependent property changes of the DEF may also be determined by the controller during various phase changes or other transient phenomenon experienced by the DEF. These phase changes or transient phenomenon may occur under different circumstances, such as when DEF is poured into tank 20 at its initial filling, or at points in time when the DEF is being replenished, when the fluid level in tank 20 drops below a certain point, or when the DEF has been sitting in tank 20 for a certain period of time, such as when a machine that includes tank 20 as part of an exhaust aftertreatment system has been idle for a period of time.

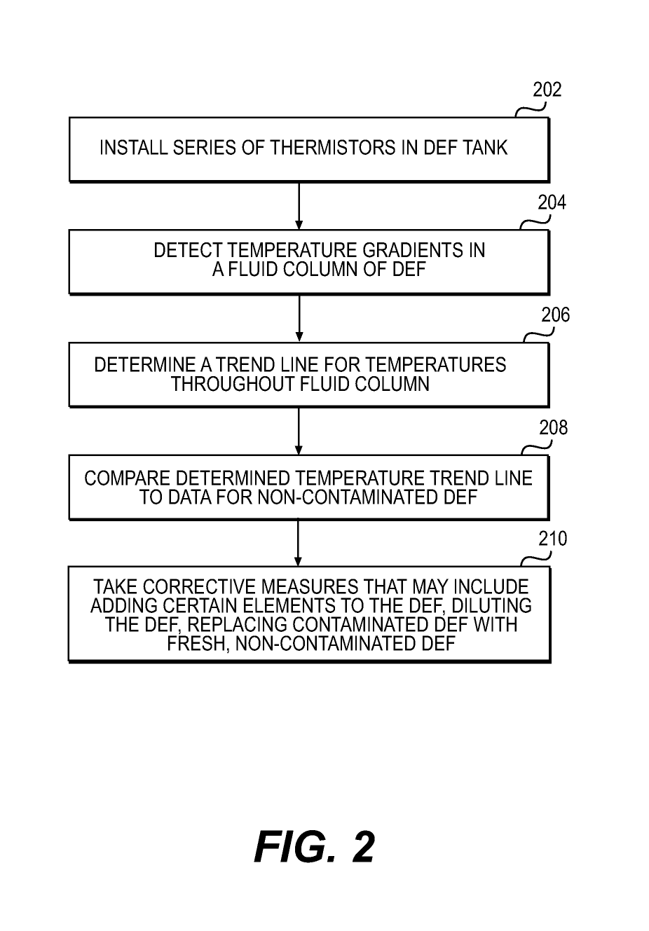

FIG. 2 illustrates steps of an exemplary disclosed method that may be performed to detect contamination of DEF used in a SCR process during exhaust gas aftertreatment. FIG. 2 will be discussed in the following section in order to further illustrate the disclosed concepts.

### INDUSTRIAL APPLICABILITY

The exemplary method for detecting contamination of a DEF containing reductant used in a selective catalytic reduction process (SCR), as set forth in the present disclosure, may be used with any power system where it is desirable to minimize NOₓ levels in combustion exhaust by using a high quality reductant. A high quality reductant is defined as a reductant having the proper composition for efficient conversion of NOₓ, and substantially free from contaminants that may affect the SCR process, or otherwise potentially harm the power system or the exhaust aftertreatment system. Such power systems may be employed with any type of machine useful in performing one or more tasks. Machines that may benefit from the methods disclosed herein may include, for example, wheel loaders, excavators, graders, on-highway vehicles, off-highway vehicles, locomotives, and/or other like machines, and such tasks may include those typical in mining, construction, excavation, farming, transportation, and/or other industries.

A power system that may benefit from the DEF contamination detection system of the present disclosure may include an air induction system, which may pressurize and force air or a mixture of air and fuel into cylinders of the power system for subsequent combustion. The fuel and air mixture may be combusted by the power system to produce a mechanical work output and an exhaust flow of hot gases. The exhaust flow may contain a complex mixture of air pollutants, which can include NOₓ and particulate matter. As this exhaust flow is directed from the cylinders of the power system through a particulate collection device and exhaust treatment device, soot may be collected and burned away, and NOₓ may be reduced to H₂O and N₂. Simultaneously, exhaust may be drawn through a cooler and redirected back into the air induction system for subsequent combustion, resulting in a lower production of NOₓ by the power system. The disclosed system and method for detecting contamination of DEF may be combined with existing DEF level sensors within tank 20 (not shown) in order to ensure that the proper quantity and quality of DEF is available for performing effective and efficient exhaust aftertreatment to clean NOₓ from the exhaust produced by the power system.

FIG. 2 illustrates at least some of the steps that may be involved in a process for detecting contamination of DEF in a tank of DEF to be used during a SCR process. At Step: 202, a series of temperature sensors such as thermistors may be installed along a fluid column within a tank that may carry the DEF used in SCR. As discussed above, the fluid column may be a defined area having any of a variety of different possible configurations within tank 20, and in some implementations, this area may be defined by one or more walls within tank 20 to form a compartment within tank 20. The wall or walls defining fluid column 30 in the implementation illustrated in FIG. 1 may also provide mounting structure for maintaining the placement of temperature sensors 102, 104, 106, 108 along fluid column 30 within tank 20. In certain implementations, an existing DEF level sensor may be modified or supplemented with the temperature sensors of the present disclosure. Fluid column 30 may also be defined to extend across various zones or regions within tank 20, with each zone or region possibly containing fluid of different composition. In the implementation illustrated in FIG. 1, fluid column 30 extends from a first zone containing DEF fluid 44 through a second zone containing non-DEF fluid. Alternately or in addition, different zones within tank 20 may contain DEF with a desired purity and composition, and other zones where the DEF contains contaminates or a composition that deviates from a desired composition. A desired composition of DEF may provide an efficient and effective conversion of NOₓ contained within exhaust gases produced by a power system, as discussed above.

At Step: 204, a controller or processor (not shown) may receive signals from the series of thermistors, with the signals being indicative of temperatures at different positions along fluid column 30. The controller may then detect temperature gradients along fluid column 30. As discussed above, the detected temperature gradients may be gradients that are a function of position along fluid column 30 and/or gradients that are a function of time. The temperature gradients may be detected on an ongoing basis, and continually updated as a way of continuously monitoring the quality of the DEF contained within tank 20. In various alternative implementations, temperature gradients along fluid column 30 may be detected during a possible phase change of the DEF or other transient phenomenon that may occur under certain operational conditions or circumstances, such as during starting of the power system during weather with ambient temperatures colder than normal for the location of the power system, or when adding or refilling DEF to tank 20.

At Step: 206, a controller may determine a trend line or other behavioral pattern for temperatures throughout fluid column 30 under various operational conditions or circumstances, and/or on an ongoing basis. A plurality of trend lines or other patterns may be determined under a variety of different operating conditions and for a variety of different reductants of different composition. This information may be stored or communicated to other processors, over wired or wireless links. The data may become part of a library of data associated with different power systems, operating conditions, ambient conditions, load conditions, or compositions of reductant. At Step: 208, a controller or processor may compare the determined temperature trend lines or other behavioral patterns with trend lines, data, or maps for non-contaminated DEF having a known composition. The data for non-contaminated DEF may be obtained by testing a reference sample of DEF supplied to tank 20 and along fluid column 30 under the same conditions that are later present when testing a test sample of DEF. Additional techniques may be applied to confirm that the reference sample of DEF has the composition desired for establishing reference trend lines or patterns of temperature gradients. For example, the NOₓ content entering a SCR process using the reference sample of DEF may be compared to the NOₓ content exiting the SCR process. The determined ratio of NOₓ may then be compared to a known desired conversion efficiency ratio for removal of NOₓ. Once known trend lines or behavioral patterns of temperature gradients representative of DEF having the desired characteristics have been established, the system and processes set forth in this disclosure provide a very cost-effective and efficient way of detecting contamination in DEF.

An additional Step: 210 may include possible actions that may be taken upon a determination that the DEF is contaminated. This step may include adding one or more elements to change the composition of the DEF, diluting the DEF to bring it to a desired composition, or replacing the contaminated DEF contained within tank 20 with fresh, non-contaminated DEF having the desired composition.

It will be apparent to those skilled in the art that various modifications and variations can be made to the disclosed method for detecting contaminates in DEF without departing from the scope of the disclosure. Other embodiments of the system and method will be apparent to those skilled in the art from consideration of the specification and practice of the method disclosed herein. It is intended that the specification and examples be considered as exemplary only, with a true scope of the disclosure being indicated by the following claims and their equivalents.

What is claimed is:

1. A method of detecting contamination in Diesel Exhaust Fluid (DEF) contained within a tank including a plurality of temperature sensors arranged along a fluid column defined within the tank, the method comprising:
detecting a temperature of the fluid at each of the plurality of temperature sensors along the fluid column;
determining temperature gradients along the fluid column from the temperatures detected by the plurality of temperature sensors; and
comparing the temperature gradients along the fluid column with a set of reference temperature gradients.

2. The method of claim 1, wherein the set of reference temperature gradients are retrieved from a look-up table or other dataset.

3. The method of claim 1, wherein the set of reference temperature gradients are determined by measuring temperatures along a similarly configured column of fluid in a tank containing DEF known to be of a desired composition.

4. The method of claim 1, wherein the plurality of temperature sensors are arranged along a vertical fluid column within a tank containing the DEF to be tested.

5. The method of claim 1, wherein the plurality of temperature sensors are arranged along a fluid column that includes fluids of different compositions within the tank containing DEF.

6. The method of claim 1, further including detecting changes in the temperature of the fluid at each of the plurality of temperature sensors along the fluid column as a function of time.

7. The method of claim 6, further including detecting the changes in the temperature of the fluid at each of the plurality of temperature sensors as the DEF in the tank undergoes a phase change.

8. The method of claim 7, wherein the detecting the changes in the temperature of the fluid occurs during a change in operational characteristics of a power supply having an exhaust aftertreatment system that uses the DEF.

9. The method of claim 8, wherein the phase change is occurring during starting of the power supply in ambient temperatures that are colder than normal operating temperatures for the power supply.

10. An apparatus for detecting contamination in a tank of DEF containing reductant used in a selective catalytic reduction process, the apparatus comprising:
a plurality of temperature sensors arranged along a fluid column within the tank, each of the temperature sensors configured to detect a temperature of the fluid at the position of each of the plurality of temperature sensors along the fluid column; and
a controller configured to determine temperature gradients along the fluid column from the temperatures detected by the plurality of temperature sensors.

11. The apparatus of claim 10, wherein the controller is further configured to compare the temperature gradients along the fluid column with a set of reference temperature gradients.

12. The apparatus of claim 11, wherein the controller is configured to retrieve the set of reference temperature gradients from a look-up table or other dataset.

13. The apparatus of claim 11, wherein the controller is configured to determine the set of reference temperature gradients from temperatures along a similarly configured column of fluid in a tank containing DEF known to be of a desired composition.

14. The apparatus of claim 10, wherein the plurality of temperature sensors are arranged along a vertical fluid column within a tank containing the DEF to be tested.

15. The apparatus of claim 10, wherein the plurality of temperature sensors are arranged along a fluid column that includes fluids of different compositions within the tank containing DEF.

16. The apparatus of claim 10, wherein the controller is further configured to detect changes in the temperature of the fluid at each of the plurality of temperature sensors along the fluid column as a function of time.

17. The apparatus of claim 16, wherein the controller is further configured to detect the changes in the temperature of the fluid at each of the plurality of temperature sensors as the DEF in the tank undergoes a phase change.

18. The apparatus of claim 17, wherein the controller is configured to detect the changes in the temperature of the fluid at each of the plurality of temperature sensors as the DEF in the tank is undergoing a phase change during a change in operational characteristics of a power supply having an exhaust aftertreatment system that uses the DEF.

19. The apparatus of claim 18, wherein the controller is configured to detect the changes in the temperature of the fluid as a phase change is occurring during starting of the power supply in ambient temperatures colder than normal operating temperatures for the power supply.

20. A method of detecting contamination in Diesel Exhaust Fluid (DEF) contained within a tank including a plurality of temperature sensors arranged along a fluid column defined within the tank, the method comprising:
detecting a temperature of the fluid at each of the plurality of temperature sensors along the fluid column;
determining temperature gradients along the fluid column from the temperatures detected by the plurality of temperature sensors;
detecting changes in the temperature of the fluid at each of the plurality of temperature sensors along the fluid column as a function of time as the DEF in the tank undergoes a phase change;
determining a trend in the temperature of the fluid from at least one of the temperature gradients along the fluid column and the changes in the temperature of the fluid as a function of time;
comparing the trend in the temperature of the fluid with data from a reference sample of DEF; and
taking action that includes one or more of adding a chemical to contaminated DEF, diluting contaminated DEF, and replacing contaminated DEF.
